(19) United States
(12) Patent Application Publication
(10) Pub. No.: US 2009/0060270 A1
(43) Pub. Date: Mar. 5, 2009

(54) Image Detection Method

(75) Inventors: Pin-Chang Lee, Taipei (TW); Ruei-Chang Hsu, Taipei (TW)

Correspondence Address: APEX JURIS, PLLC, 12733 LAKE CITY WAY NORTHEAST, SEATTLE, WA, 98125, US

(73) Assignee: MICRO-STAR INT'L CO., LTD., Jung-He City (TW)

(21) Appl. No.: 11/871,429

(22) Filed: Oct. 12, 2007

(30) Foreign Application Priority Data
Aug. 29, 2007 (TW) 096132140

(51) Int. Cl. G06K 9/00

(52) U.S. Cl. 382/103

(57) ABSTRACT

An image detection method is performed by a computer to determine whether or not an image in a region shot by a camera changes. According to the method, consecutive images shot by the camera are captured, and at least one anchored frame for the consecutive images is set. Whether or not the images in the anchored frame should or should not change is determined, and a signal is transmitted to determine whether or not the detected region is normal or not. Then, a notification signal is transmitted automatically to remind supervisors to closely observe the detected region.

### CROSS-REFERENCE TO RELATED APPLICATIONS

This non-provisional application claims priority under 35 U.S.C. § 119(a) on Patent Application No(s). 096132140 filed in Taiwan, R.O.C. on Aug. 29, 2007, the entire contents of which are hereby incorporated by reference.

### BACKGROUND OF THE INVENTION

1. Field of Invention

The present invention relates to an image detection method, and more particularly to an image detection method of transmitting detection normal/abnormal signals according to image changes in a detected region within a set period of time.

2. Related Art

With the improvement of digital photography technique and large decrease of the prices of digital photography related equipments, digital photography has been widely applied in people's daily life. So-called digital photography generally refers to a shooting method to convert the shot characters and scenes into a digital file and store the digital file into a storage medium. For example, Web CAM, digital video (DV), monitoring camera, or camera module on a mobile phone/camera are all digital photography equipments commonly seen at present. Along with the popularization of digital photography equipments, diversified applications of the digital photography equipments are gradually developed. For example, a user can have a meeting with friends at a distance through video equipments such as Web CAM, and a building manager can supervise people entering or exiting the building through a monitoring camera.

Some digital photography equipments have the function of automatic focusing, which can clearly show scenes and characters; while most of the digital photography equipments can only display the shot images on the screen for users to observe. For example, a monitoring camera is mounted on the gateway of each floor of a building, and the shot images are transmitted to a central monitoring screen. Then, the shot pictures are switched circularly by a monitoring system, and the manager supervises people entering/exiting the building through the screen. As the monitoring system operates manually, human mistakes may easily occur (for example, the departure of the manager from the central monitoring screen), thus greatly alleviating the efficacy of the monitoring system (fail to detect strangers passing through the gateway). Moreover, some monitoring systems adjust the monitoring camera according to the image change. For example, ROC patent publication No. 200714039 discloses a monitoring system that determines the differences of the shot images and tracks and amplifies the differences of the images. ROC patent No. 1260494 discloses a remote monitoring system, in which the amount of data transmission is relatively large when the shot images change, and at this time, the remote supervisor starts to download the shot image data. However, the aforementioned system only performs detection determination when “actions occur” in the monitored region, and whether or not there is an abnormal action is fed back. Actually, in some situations, for example, in a health care monitoring system for the old living alone, it is considered an abnormal phenomenon if there is no image change in some special areas, such as the washing room or the bed, for a long time. Nevertheless, the current monitoring system cannot detect such abnormal phenomena.

### SUMMARY OF THE INVENTION

In view of the above problems existing in the digital photography that, automatic action perception and feed-back cannot be applied to multiple desired regions, an image detection method is provided, which is performed by a computer to analyze the change in images shot by a camera, so as to feed back the image change in the desired regions in real time.

To achieve the above objective of feeding back the image change in multiple desired regions, the image detection method provided by the present invention includes: first, capturing at least one consecutive image shot by the camera; then, setting at least one anchored frame for the consecutive images; next, setting the images in the anchored frames to change in a time parameter, performing a step of determining the image change, and outputting a first signal when the images change in the time parameter; finally, setting the images in the anchored frames not to change in the time parameter, performing the step of determining the image change, and outputting a second signal when the images do not change in the time parameter.

The image detection method according to a preferred embodiment of the present invention further includes: outputting a third signal when the images in the anchored frames are set to change in the time parameter but do not change, and outputting a fourth signal when the images in the anchored frames are set not to change in the time parameter but change. The first, second signals are normal signals preset by the system, and the third, fourth signals are abnormal signals preset by the system. The aforementioned normal or abnormal signals can be reminded to the users by means of an alert message, alert lamp, alert sound, and so on.

The image detection method according to a preferred embodiment of the present invention further includes a step of determining the image change. The step includes: capturing two consecutive images shot in the time parameter; comparing an RGB value of each pixel in the anchored frames of the consecutive images, and calculating an RGB value variation; and if the RGB value variation exceeds a recommended value, determining the images in the anchored frames change. The aforementioned RGB value variation is, for example, a mean-square error (MSE) of the RGB values.

The image detection method according to a preferred embodiment of the present invention further includes setting a detection frequency parameter, so as to control the frequency for detecting the image change. That is, the frequency of performing the step of detecting the image change is set. When the first and second signals are continuously received by the monitoring system, nothing abnormal occurs to the monitored region. Therefore, the detection frequency parameter is automatically reduced by the system, such that the interval of performing the step of detecting the image change is prolonged. When the third and fourth signals are continuously received, something abnormal continuously occurs to the monitored region. Therefore, the detection frequency parameter is automatically increased by the system, such that the interval of performing the step of detecting the image change is shortened.

In view of the above, according to the image detection method of the present invention, at least one consecutive image shot by a camera is captured; whether or not the consecutive images change is determined by an RGB value variation of desired anchored frames set for the consecutive images; a digital signal (the first signal to the fourth signal) to be transmitted is determined by the fact whether or not the images in the anchored frames are set to change, so as to automatically perform action perception and feed-back on multiple regions; and a corresponding digital signal is sent according to the fact whether or not the images in the regions are set to/not to change in a preset period of time.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a flow chart of an image detection method.

FIGS. 2A and 2B are schematic views of the system architecture of applying the image detection method to a remote detection system.

FIGS. 3A and 3B are schematic views of the system architecture of applying the image detection method to an interactive computer game system.

FIG. 4 is another flow chart of an image detection method.

### DETAILED DESCRIPTION OF THE INVENTION

The objective and implementation of the present invention are illustrated below with the preferred embodiments. However, the concept of the present invention can also be applied to other scopes. The following embodiments are only used to illustrate the objective and implementation of the present invention, instead of limiting the scope thereof.

### The First Embodiment

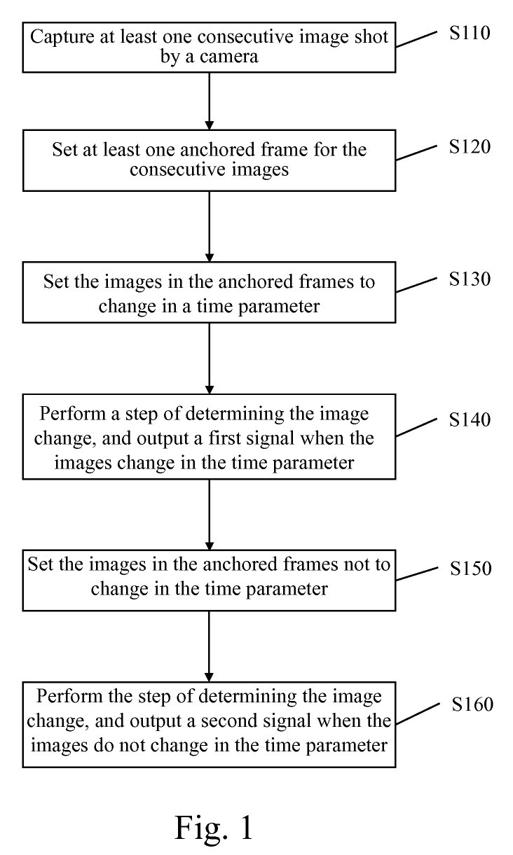

FIG. 1 is a flow chart of an image detection method. Referring to FIG. 1, in the first embodiment, the image detection method includes: first, capturing at least one consecutive image shot by a camera (Step S10); then, setting at least one anchored frame for the consecutive images (Step S120); next, setting the images in the anchored frames to change in a time parameter (Step S130); at this time, performing a step of determining the image change, and outputting a first signal when the images change in the time parameter (Step S140); finally, setting the images in the anchored frames not to change in the time parameter (Step S150); at this time, performing the step of determining the image change, and outputting a second signal when the images do not change in the time parameter (Step S160).

Accordingly, a third signal is output when the images in the anchored frames are set to change in a period of time but do not change, and on the contrary, a fourth signal is output when the images in the anchored frames are set not to change in a period of time but change. In the system performing the image detection method, the first, second signals are preset as normal signals, and the third, fourth signals are preset as abnormal signals. Moreover, the above normal or abnormal signals are represented by means of, but not limited to, an alert message, alert lamp, or alert sound.

The process of the image detection method will be illustrated in detail herein. First, a region to be detected is shot by a camera (or DV), and a plurality of desired small regions is set in the shot image. These small regions are referred to as anchored frames. The anchored frames can be set by the users through the user interface of the camera directly, or through image detection application software executed on a computer. Besides, a time parameter directing to each anchored frame can be set at the same time when the anchored frames are set, so as to control the time duration of a single detection on the anchored frames. The anchored frames can be set with a time parameter with or without the same length. In other embodiments, a “detection frequency parameter” is further set to control a program in which the change of the shot image is periodically detected with a processing chip in a computer or camera (i.e., to determine whether or not the RGB value variation of the shot images in the anchored frames changes).

The step of detecting the change of the shot image includes: first, starting to detect the change of the shot image at a set time, and capturing two consecutive images with a processing chip in a computer or camera; after that, setting anchored frames of the images, comparing an RGB value of each pixel in the anchored frames, and calculating an RGB value variation. In this embodiment, the RGB value variation is directly calculated by each pixel in the anchored frames of the two images, for example, by calculating the MSE of the RGB values. When the RGB value variation exceeds a recommended value (the magnitude of the recommended value may affect the sensitivity of detecting the image change, and the recommended value of this embodiment can also be set through, but not limited to, the user interface of the camera or the image detection application software), there are changes in the anchored frames of the two consecutive images. The RGB value variation can be calculated as follows.

An RGB mean difference of each pixel in the anchored frames is calculated, and the formula is:

$$RGB mean difference = \sum \frac{\vert {R}_{new} - {R}_{old} \vert + \vert {G}_{new} - {G}_{old} \vert + \vert {B}_{new} - {B}_{old} \vert}{3} .$$

Then, an RGB standard deviation of each pixel is deduced, and the

$$RGB standard deviation = \frac{\sqrt{{\sum }_{1}^{n} {( {X}_{i} - \overline{X} )}^{2}}}{n} ;$$

further, an RGB value variation (i.e., the MSE of the RGB values) is deduced, and the

$$RGB value variation = \frac{\sum ( {X}_{i} - \overline{X} ) ( {Y}_{i} - \overline{Y} )}{{nS}_{x} {S}_{y}} ,$$

in which n represents a pixel value in the anchored frames, Xi represents the actual RGB value of a pixel, and X̅ represents the RGB mean difference in the anchored frames.

Further, in some embodiments, if the first and second signals are continuously received, there is no change in the detected/monitored region for a long time, so the detection frequency parameter is reduced, and the interval of performing the detection on the monitored region is prolonged. On the contrary, if the third and fourth signals are continuously received, there are frequent changes in the detected/monitored region, so the detection frequency parameter is increased to detect the detected/monitored region frequently to feed back the status of the changes in real time.

### The Second Embodiment

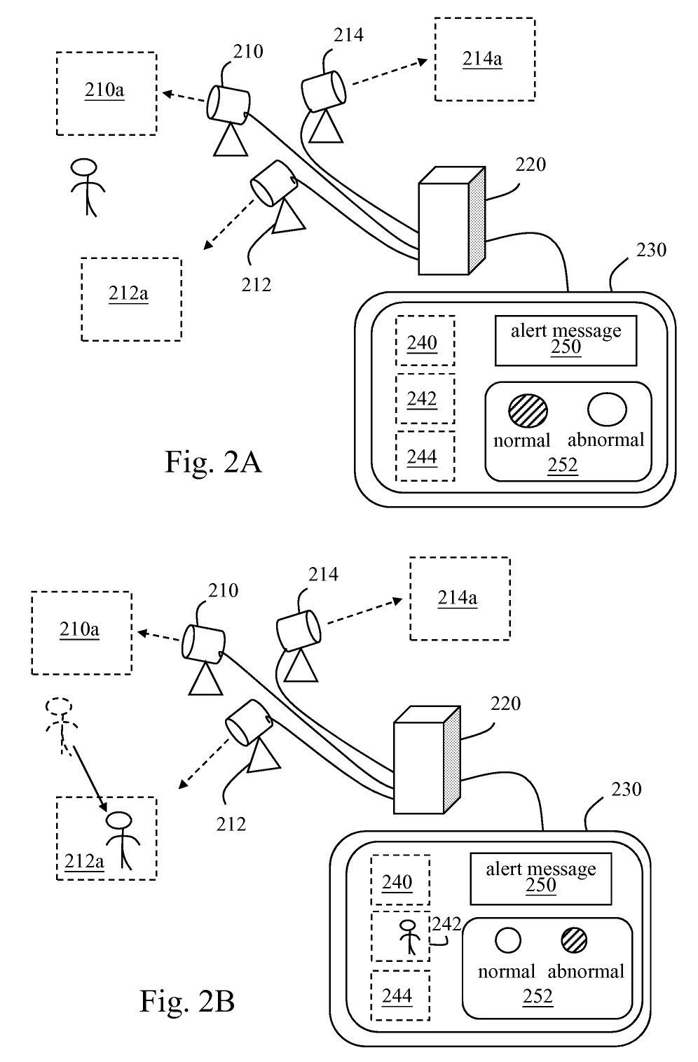

A practical example is provided by the second embodiment to clearly illustrate the technique of the present invention. FIGS. 2A and 2B are schematic views of the system architecture of applying the image detection method to a remote detection system. Sequentially referring to FIG. 2A and FIG. 2B, in this preferred embodiment, three cameras (210, 212, 214) are used to respectively monitor three monitored regions (210a, 212a, 214a), and send the shot pictures to a computer 220 to be displayed on a screen 230. Before shooting, the user adopts an image detection application software installed in the computer 220 to set anchored frames (240, 242, 244), and the anchored frames are regions in the pictures that the user is interested in. The screen 230 not only shows the anchored frames (240, 242, 244) in the shot pictures, but also other stuffs such as an alert message 250 and an alert lamp 252. Referring to FIG. 2A, nobody is allowed to enter or exit from the set monitored regions (especially the anchored frames) within a set time parameter T. After the monitoring is started, nobody enters or exits from the monitored regions, so the cameras (210, 212, 214) capture nothing. Then, the cameras (210, 212, 214) send the shot pictures to the computer 220, and a program of detecting the image change is executed by the computer. The computer determines whether or not the received multiple consecutive images change according to the change of the RGB value variation of the images shot in the anchored frames. In the set time parameter T, as there is no image change in all the anchored frames (240, 242, 244), the alert lamp 252 indicating “normal” is on, and the alert message 250 saying “everything is normal” is shown. Next, referring to FIG. 2B, at this time, somebody enters the monitored regions not allowed to enter/exit, the cameras (210, 212, 214) transmit the shot images to the computer 220, and the program of detecting the image change is continuously executed by the computer. In the set time parameter T, some change in the anchored frame 242 is determined. Then, the alert message 250 saying “Attention, abnormal status is detected!” is shown on the screen 230, meanwhile the alert lamp 252 indicating “abnormal” is on, and an alert sound is released to remind the supervisor to pay attention to the screen.

This embodiment can also be applied to a remote monitoring system for caring and managing. The remote supervisor sets the daily living and accessing places of people under care as monitored regions, and shoots these monitored regions (especially the anchored frames). Moreover, the remote supervisor also sets a time parameter T to determine whether or not there is image change in the shot monitored regions, so as to make sure that those under care can maintain their daily activities. The computer keeps on executing the program of detecting the image change. If there is no image change in the set anchored frames within the time parameter T, the alert message 250 is sent and the alert lamp 252 indicating “abnormal” is shown on the screen, so as to notify the remote supervisor to pay close attention to the current conditions of the people under care, and to see whether or not those under care need help in real time.

### The Third Embodiment

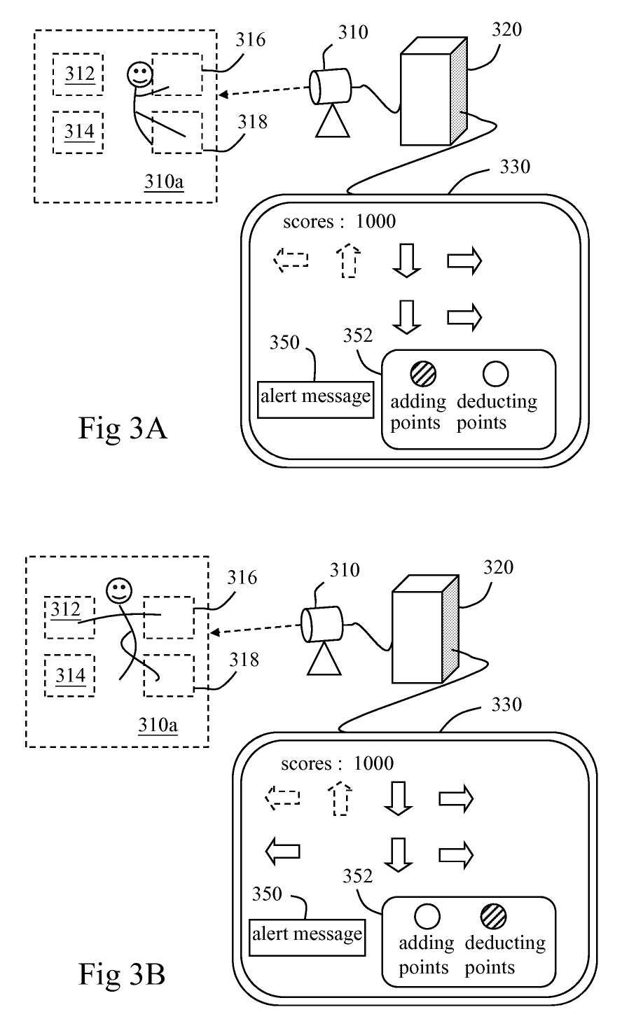

In a third embodiment, for example, the image detection method is applied to an interactive computer game, like Dance Dance Revolution (DDR). FIGS. 3A and 3B are schematic views of the system architecture of applying the image detection method to an interactive computer game system. Sequentially referring to FIG. 3A and FIG. 3B, the game goes like this: a user stands in the region detectable by a camera 310, and moves following the hints shown by arrows on a screen 330. If the player finishes the movements exactly according to the hints, a high score is given and the game is over.

The camera 310 shoots the monitored region (i.e., the moving range of the player), and transmits the shot images to a computer 320. The monitored region 310a is divided into multiple anchored frames (312, 314, 316, 318), corresponding to arrows in the front row of the screen (arrows indicating four directions of up, down, left, and right). During the game, movements are designated and hints shown by arrows are given in the next row. The player must react correspondingly during a limited period of time (i.e., a time parameter T). For example, when arrows indicating down and right directions are shown on the screen, the player must move his hand and leg in the regions corresponding to the anchored frames 316, 318 in the monitored region 310a. After the movement is finished in the limited period of time, an alert lamp 352 indicating “adding points” is on, and a text message (alert message) 350 saying, for example, “Cool” is shown on the screen 330. If the player finishes designated movements consecutively without any mistake, the game will automatically shorten the limited time to raise its difficulty.

Moreover, the game also sets that, during the limited period of time, no movement except the designated ones should appear in the regions corresponding to the anchored frames 316, 318 in the monitored region 310a, and scores will be deducted for this violation. Referring to FIG. 3B, the game tells the player to move his hand and leg in the regions corresponding to the anchored frames 316, 318, but the player moves his hands and leg in the regions corresponding to the anchored frames 312, 316, 318. After executing the program of detecting the image change, the computer 320 discovers that something abnormal occurs in the anchored frame 312, so the alert lamp 352 indicating “deducting points” is on, and the alert message 350 saying “Wrong” is shown. In some embodiments, after the player performs a “Wrong” movement, an alert sound is released by the speaker of the computer, so as to raise the interaction of the game. If the image detection method of the present invention is applied to such computer games (such as DDR), comparing to similar games with press sensing elements (such as DDR pad), the player does not have to concentrate on the feet movement, and unfair phenomena like getting a high score by pressing all the sensing elements at the same time in the game can be avoided.

### The Fourth Embodiment

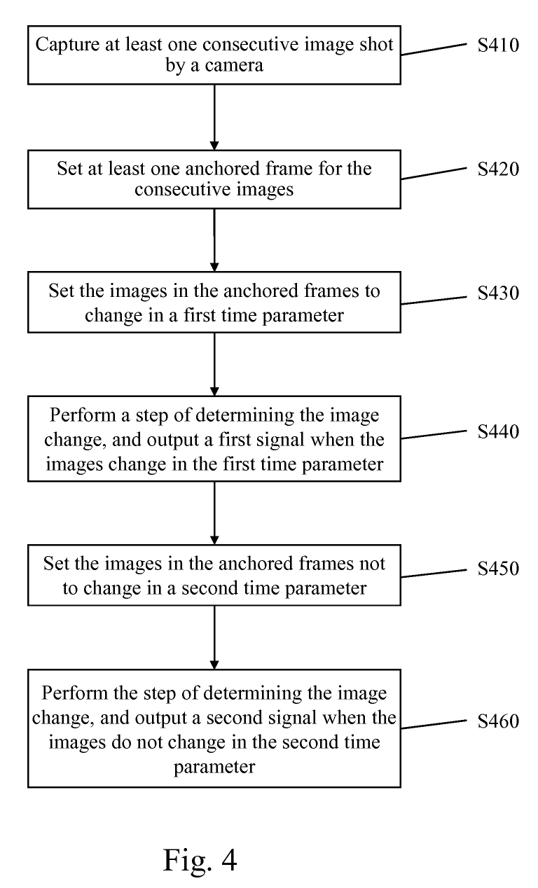

The implementation process of this embodiment is similar to that of the first embodiment, and the difference is as follows. In this embodiment, different parameters (a first and a second time parameter) are set according to the fact whether the images in the anchored frames “should change” or “should not change”, so as to adjust the length of the detection time respectively according to requirements of the detection (for example, to prolong the time length of each detection of the anchored frames in which the images must change). FIG. 4 is another flow chart of an image detection method. Referring to FIG. 4, the image detection method of this embodiment includes: first, capturing at least one consecutive image shot by a camera (Step S410); then, setting at least one anchored frame for the consecutive images (Step S420); next, setting the images in the anchored frames to change in a first time parameter (Step S430); at this time, performing a step to determine the image change, and outputting a first signal when the images change in the first time parameter (Step S440); finally, setting the images in the anchored frames not to change in a second time parameter (Step S450); at this time, performing the step of determining the image change, and outputting a second signal when the images do not change in the second time parameter (Step S460). Moreover, a third signal is output when the images in the anchored frames are set to change in the first time parameter but not change, and a fourth signal is output when the images in the anchored frames are set not to change in the second time parameter but change.

Accordingly, in this embodiment, the first and second time parameters are adjustable time parameters, and their lengths can be, for example, changed according to the fact whether or not the signal (the first signal to the fourth signal) is output continuously. For example, when the first or the second signal is output continuously which represents that the monitored region is normal, the time duration of each detection can be shortened, so the first time parameter is reduced. On the contrary, if the monitored region should be detected for a long time, the time duration of each detection (the first time parameter) should be prolonged. Further, each anchored frame can be set with a first or second time parameter of different length, such that the detection frequency and the time duration of each detection can be respectively set according to the detection strategy of the anchored frames.

The image detection method of the present invention has a large variety of applications, which will not be listed herein. However, those skilled in the art should be able to apply this method in fields such as environment safety and remote monitoring according to the teaching of the present invention. In view of the above, the present invention sets multiple anchored frames for the shot images, and determines whether or not the images in the anchored frames change in a preset period of time, such that “whether or not the images should change” which is set before detection is performed and a computer transmits a corresponding digital signal accordingly. Therefore, the status of the monitored region can be detected periodically at a set time, and the detection result can be automatically fed back.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An image detection method, performed by a computer, for determining whether or not an image shot by a camera changes, the image detection method comprising:
capturing at least one consecutive image shot by the camera;
setting at least one anchored frame for the consecutive images;
setting the images in the anchored frames to change in a time parameter:
performing a step of determining the image change, and outputting a first signal when the images change in the time parameter; and
setting the images in the anchored frames not to change in the time parameter:
performing the step of determining the image change, and outputting a second signal when the images do not change in the time parameter.

2. The image detection method as claimed in claim 1, further comprising outputting a third signal when the images in the anchored frames are set to change in the time parameter but do not change.

3. The image detection method as claimed in claim 1, further comprising outputting a fourth signal when the images in the anchored frames are set not to change in the time parameter but have been changed.

4. The image detection method as claimed in claim 1, wherein the first signal and the second signal are normal signals.

5. The image detection method as claimed in claim 2, wherein the third signal is an abnormal signal.

6. The image detection method as claimed in claim 3, wherein the fourth signal is an abnormal signal.

7. The image detection method as claimed in claim 4, wherein the image detection method expresses a normal signal through one selected from a group consisting of an alert message, an alert lamp, and an alert sound.

8. The image detection method as claimed in claim 5, wherein the image detection method expresses an abnormal signal through one selected from a group consisting of an alert message, an alert lamp, and an alert sound.

9. The image detection method as claimed in claim 1, wherein the step of determining the image change comprises:
capturing two consecutive images shot in the time parameter;
comparing an RGB value of each pixel in the anchored frames of the consecutive images, and calculating an RGB value variation; and
if the RGB value variation exceeds a recommended value, determining the images in the anchored frames change.

10. The image detection method as claimed in claim 9, wherein the RGB value variation is a mean-square error (MSE) of the RGB values.

11. The image detection method as claimed in claim 3, further comprising setting a detection frequency parameter, so as to control the frequency for detecting the image change, wherein:
when the first and second signals are continuously received, the detection frequency parameter is reduced; and
when the third and fourth signals are continuously received, the detection frequency parameter is increased.

12. An image detection method, performed by a computer, for determining whether or not images shot by a camera change, the image detection method comprising:
capturing at least one consecutive image shot by the camera;
setting at least one anchored frame for the consecutive images;
setting the images in the anchored frames to change in a first time parameter:
performing a step of determining the image change, and outputting a first signal when the images change in the first time parameter; and
setting the images in the anchored frames not to change in a second time parameter:
performing the step of determining the image change, and outputting a second signal when the images do not change in the second time parameter.

13. The image detection method as claimed in claim 12, further comprising outputting a third signal when the images in the anchored frames are set to change in the first or the second time parameter but do not change.

14. The image detection method as claimed in claim 12, further comprising outputting a fourth signal when the images in the anchored frames are set not to change in the first or the second time parameter but change.

15. The image detection method as claimed in claim 12, wherein the first and second signals are normal signals.

16. The image detection method as claimed in claim 13, wherein the third signal is an abnormal signal.

17. The image detection method as claimed in claim 14, wherein the fourth signal is an abnormal signal.

18. The image detection method as claimed in claim 12, wherein the first and second time parameters are adjustable time parameters.

19. The image detection method as claimed in claim 12, wherein the anchored frames are respectively set with the corresponding first or second time parameter.
